(19) United States
(12) Patent Application Publication
(10) Pub. No.: US 2009/0084813 A1
(43) Pub. Date: Apr. 2, 2009

(54) SOAP DISPENSING APPARATUS FOR COUNTER-MOUNTED AUTOMATIC SOAP DISPENSOR

(76) Inventor: Jan Sun CHEN, Taipei City (TW)

Correspondence Address: BIRCH STEWART KOLASCH & BIRCH, PO BOX 747, FALLS CHURCH, VA, 22040-0747, US

(21) Appl. No.: 11/866,237

(22) Filed: Oct. 2, 2007

(51) Int. Cl. B67D 5/08; B65D 88/54

(52) U.S. Cl. 222/52; 222/333

(57) ABSTRACT

A soap dispensing apparatus for an automatic countertop soap dispenser, comprising a motor and a reduction gear set driven thereby, said reduction gear set with an output shaft coupled to the drive gear of a pair of soap displacing gears in mesh side by side, said soap displacing gears disposed, by precision fit, in a chamber that extends upward and downward to form an outlet passage and an inlet passage, wherein the outlet passage is connected to a countertop soap dispensing spout, and the inlet passage to a soap containing reservoir. Whereby an upward suction force induced by the rotation in mesh of the drive gear and the idler gear of said soap displacing gears is used to suck the liquid soap through the inlet passage and out of the outlet passage, thus to lift the liquid soap above countertop to achieve soap dispensing.

### BACKGROUND OF THE INVENTION

1. Field of the Invention

The present invention relates to a soap dispensing apparatus, in particular, to a soap dispensing apparatus for counter-mounted automatic soap dispensers that uses the upward suction induced by the rotation of a pair of gears in mesh to move liquid soap from a lower position to a relatively higher counter for dispensing.

2. Description of the Prior Art

Automatic soap dispensers are widely used in household or public places to offer hygienic use by means of outputting liquid soap through sensing and doing without touching the soap dispensing apparatus. Automatic soap dispensers are divided in wall-mounted ones and counter-mounted ones, depending on their installed location. Among them is an automatic soap dispenser used on top of counter provided in the U.S. Pat. No. 6,467,651. It has a structure comprising a dispensing spout and a drive box, which is operatively connected to said dispensing spout, wherein the drive box removably receives a fluid soap containing reservoir module in communication with the dispensing spout. The reservoir module has a central axis, and includes a pump mechanism and delivery tube mounted on the reservoir module in alignment with the central axis. Such an automatic soap dispenser moves the liquid soap along the delivery tube to reach the dispensing spout by means of the drive box, which actuates the pump mechanism disposed on the reservoir module when requested. But, as the dispensing tube is adapted to move in the dispensing spout when the pump mechanism is actuated, malfunction may occur. In addition, such automatic soap dispenser has a mechanism that is wholly too complex to make maintenance convenient.

### SUMMARY OF THE INVENTION

In view of the foregoing disadvantages of the prior art, the present invention has an object to provide an automatic countertop soap dispensing apparatus that has a simple structure, particularly a soap dispensing apparatus that has stable operational function, in hope that an automatic soap dispenser applying this invention can reduce possibilities of servicing and cost.

To serve the above purpose, the soap dispensing apparatus of the present invention comprises a motor, and reduction gear set it drives, said reduction gear set having an output shaft coupled to a drive gear of a pair of soap displacing gears in mesh side by side, which are disposed with precision fit inside a chamber, this chamber extending upward and downward to form an outlet passage and an inlet passage respectively; wherein, the outlet passage connects to a countertop dispensing spout, and the inlet passage, to a soap reservoir. As an upward suction force is generated by the rotation in mesh of the drive gear and idler gear of said soap displacing gears in this soap dispensing apparatus, the suction force is used to suck the liquid soap from said inlet passage and discharge it out of said outlet passage, thus completing, by elevating the liquid soap above countertop, the soap dispensing.

As the above soap dispensing apparatus uses the driving force provided by the meshing of the soap displacing gears, it requires no further pump mechanisms; consequently, the whole mechanism can be simplified, and opportunities of malfunction avoided. Moreover, the delivery tubes of the soap dispensing apparatus according to the present invention are always in a fixed state of connection whether during dispensing operation or not, opportunities of malfunction therein can thus be minimized. Therefore, a simple yet reliable soap dispensing apparatus, which when embodied in an automatic countertop soap dispenser will bring such dispenser the benefits of being easy to maintain and unlikely to malfunction, is provided in the present invention.

### BRIEF DESCRIPTION OF THE DRAWINGS

FIGS. 1 & 2 are exploded perspective views of the parts in a soap dispensing apparatus of the present invention taken from two opposite directions.

FIG. 3 is an exploded perspective view of a soap dispensing apparatus of the present invention and the other parts in an automatic countertop dispenser.

FIG. 4 is a perspective view of the status of a soap dispensing apparatus of the present invention applied to a countertop soap dispenser, wherein the soap dispensing.

FIG. 5 is a cut-away side structural view of the assembly of a soap dispensing apparatus of the present invention and the other parts of a countertop soap dispenser.

FIG. 6 is a diagram for the operation of the liquid soap delivery by the soap displacing gears inside the chamber of the end cover of a soap dispensing apparatus of the present invention.

### DESCRIPTION OF THE PREFERRED EMBODIMENT

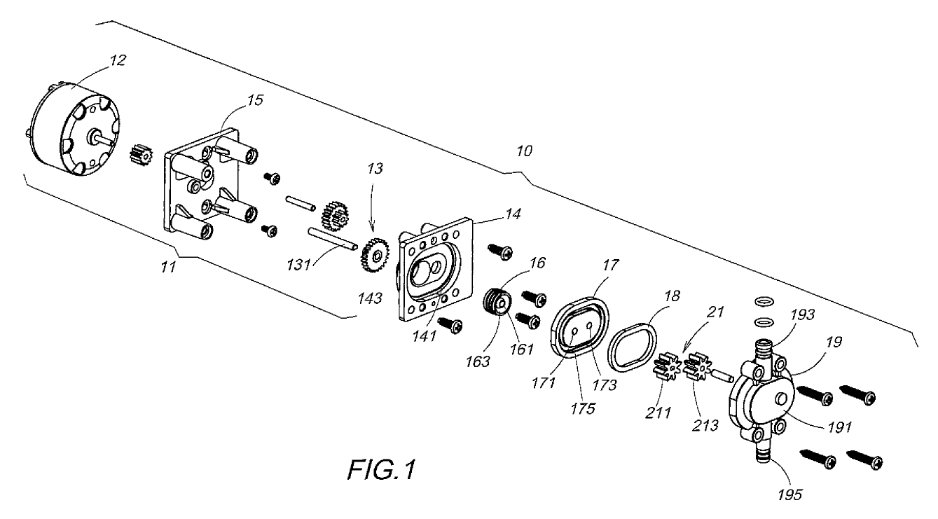

Reference will be made to the drawings and the presently preferred embodiment to describe in detail the structural characteristics and the effects of the present invention. For a preferred embodiment of the soap dispensing apparatus of the present invention for an automatic countertop soap dispenser, please refer to FIG. 1 and FIG. 2, which show the same elements of such soap dispensing apparatus in two exploded perspective views seen from opposite directions. Such soap dispensing apparatus 10 comprises: a drive device 11, which includes a motor 12 and a reduction gear set 13 driven thereby; a rear board 14 having a recessed trough 141, on which bottom a main axial groove 143 is provided; a first packer 16, which has the same profile as that of said main axial groove 143 of said rear board 14, with an axial bore 161 tightly embracing the output shaft 131 of the gear set 13 yet allowing the shaft to spin freely, said axial bore 161 having a recessed area around it to form an annular groove 163; an inlaid board 17, which has the same profile as that of the recessed trough 141 of said rear board 14, and provided on which are two axial bores 171 and 173, and a circumferential groove 175 on one side; wherein the peripheral around said axial bores 171, which allows the output shaft 131 of the gear set to extend through, forms a telescopic portion on the side facing toward said rear board 14; a second packer 18 having the same profile as that of said circumferential groove 175 of said inlaid board 17; an end cover 19, which has a chamber 191 extending upward to form an outlet passage 193 and downward to form an inlet passage 195; a circumferential groove 197 having the same profile as that of said second packer 18 further provided to the circumference of said chamber 191; a pair of soap displacing gears 21, consisting of a drive gear 211 and an idler gear 213, each in mesh with the other side by side.

The drive mechanism 11, the motor 12 and the reduction gear 13 as described above are mounted separately on both sides of a frame 15, and said rear board 14 joins the frame 15 to hold one side of the gear set 13. Said first packer 16 is inserted in the main axial groove 143 of said rear board 14; said inlaid board 17 is disposed at said recessed trough 141 of said rear board 14, and said second packer 18 is disposed in, and a little protrudes from, the circumferential groove 175 of said inlaid board 17. The output shaft 131 of the gear set 13 extends through the axial bore 161 of said first packer 16 and the axial bore 171 of said inlaid board 17 to couple with said drive gear 211 of said soap displacing gears 21, of which the drive gear 211 is further in mesh with the idler gear 213. By the circumferential groove 197 of said end cover 19 seizing said slightly protruding second packer 18 disposed in the circumferential groove 175 of said inlaid board 17, the end cover 19 hermetically conjuncts with one side of the rear board 14 and has the soap displacing gears 21 rotatably held in the chamber 191 of said end board.

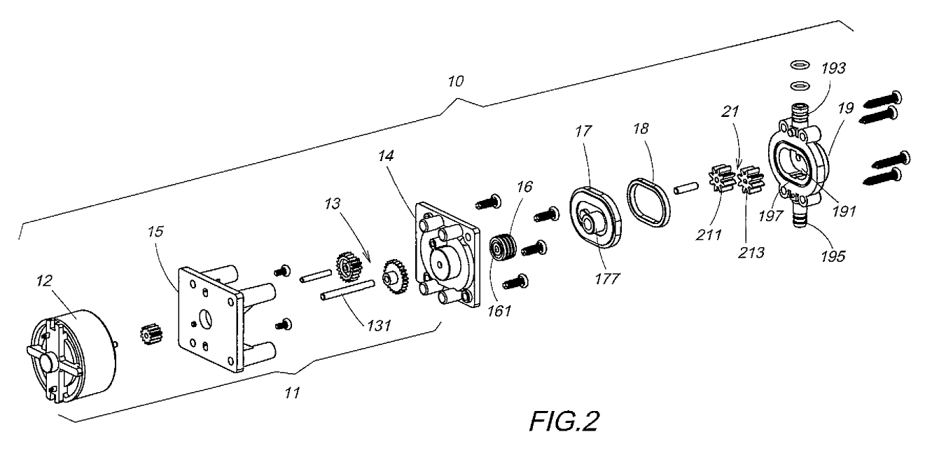

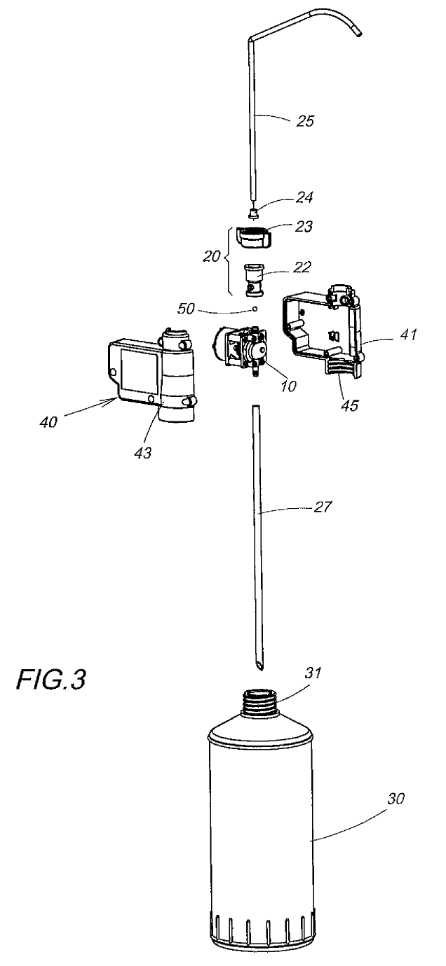

Reference is now made to FIG. 3 and FIG. 4, which show a yet preferred application of above soap dispensing apparatus after assembly. As seen, provided at and connected to the outlet passage 193 of said end cover 19 is an adaptor 20, which has a fixing rod 22 embracing said outlet passage of said end cover, a nut 23 that rotatably connects to the outlet end of said fixing rod, a socket 24 disposed in the fixing rod of the adaptor to receive one end of a countertop soap dispensing spout 25, and a countertop soap dispenser 26 that links with the soap dispensing apparatus 10 through said nut 23 of the adaptor. Similarly, in the soap dispensing apparatus 10 of the preferred embodiment, a priming tube 27 is provided to connect to the end of the inlet passage 195 of said end cover 19, and is used to extend into a soap reservoir 30. The above assembly of soap dispensing apparatus 10 with said adaptor 20 preferably further has, and is enclosed by, a housing 40, which consists of a pair of covers 41 and 43, Wherein disposed at the lower end of the housing is a nut 45 to receive the screwing in of the threaded head 31 of the soap reservoir 30 to integrate the soap reservoir 30 with the soap dispensing apparatus 10.

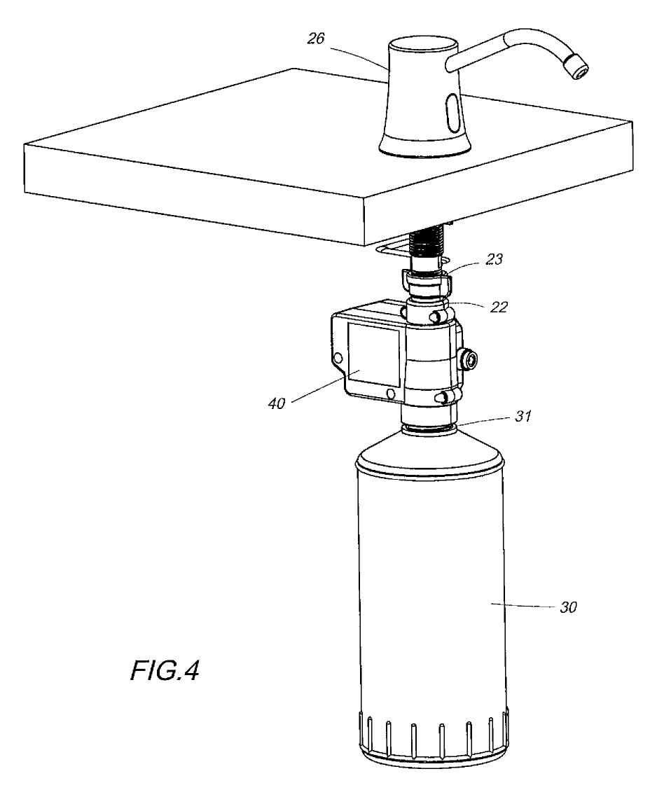

Reference is still made to FIG. 3 and further FIG. 5, which show in a preferred application of the above soap dispensing apparatus 10, a check ball 50 provided at the outlet end of the outlet tube 193 of said end cover 19. This check ball 50 is movably confined within the outlet of the outlet passage of the end cover and a port 221 of the fixing rod 22 of the adaptor 20; wherein said port 221 has a plurality of openings, so if the ball 50 is pushed against it, it still let the liquid soap through to reach the countertop dispensing spout 25.

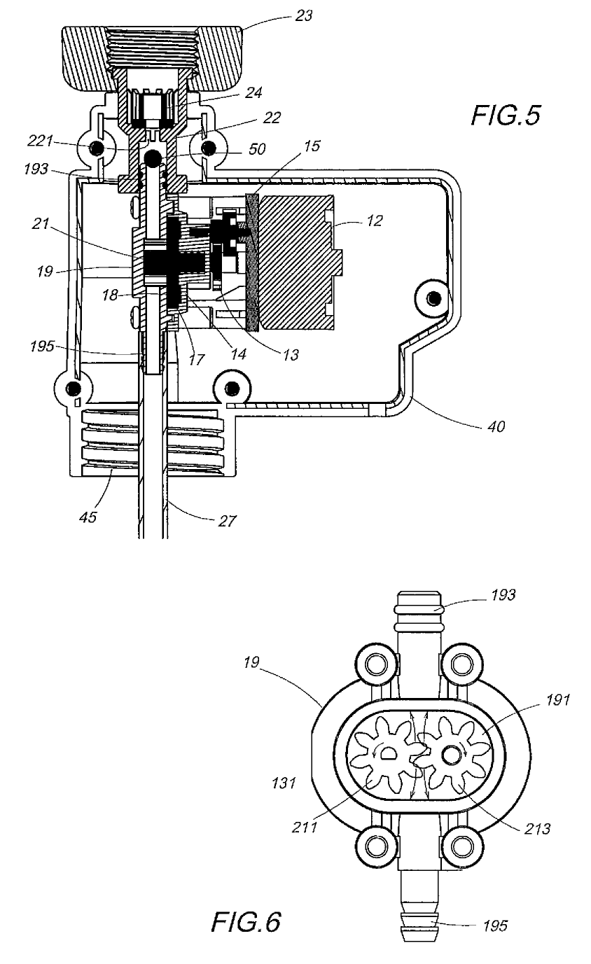

Reference is now made to FIG. 6, which shows the operation of soap dispensing of the above soap dispensing apparatus 10. In such operation, the motor 12 is used to drive the reduction gear set 13, making the output shaft drive the drive gear 211 of the soap displacing gears 21 in counter-clockwise rotation, which in turn drives the idler gear 213 to rotate in clockwise direction to create an upward suction force. This suction force sucks the liquid soap through the inlet passage 195 under into the chamber 191 and displace it out of the outlet passage 193 above the chamber 191, as shown in the direction of the arrow in the diagram. As the outer rims of above said soap displacing gears 21 are in fit with the inner wall of the chamber 191 by a very small tolerance, the liquid soap cannot but be pushed in from one side, and out from the other side, of the mesh section of the soap displacing gears 21; in such manner a force enough to lift the liquid soap to the outlet of the countertop dispensing spout 25 is generated to achieve the purpose of soap dispensing.

The above stated is only the preferred embodiment of the present invention. It should not be limiting all the structural characteristics of the present invention. Any person skilled in the art can think of a variation or modification easily without deviating from the scope of the following claimed items.

I claim:

1. A soap dispensing apparatus, for use in soap dispensing by an automatic countertop soap dispenser, comprising:
a drive device, including a motor and a reduction gear set driven thereby;
a rear board, joining a frame that holds the motor in the drive device, having a recessed area, a main shaft groove is provided on the bottom thereof;
a first packer, having the same profile as that of the main shaft groove of the rear board, and tightly disposed therein;
an inlaid board, having the same profile as that of the recessed area of the rear board, and disposed therein, said inlaid board having two shaft bores and, on one side, a circumferential groove;
a second packer, having the same profile as that of the circumferential groove of said inlaid board, and disposed therein slightly protruding therefrom;
an end cover, having a chamber extending upward to form an outlet passage and downward to form an inlet passage; a circumferential groove having the same profile as that of said second packer provided to the peripheral of said chamber, and used to contain said second packer slightly protruding from said circumferential groove of said inlaid board, enabling hermetic seal between the end cover and one side of the rear board; and
a pair of soap displacing gears, disposed in the chamber of said end cover, consisting of a drive gear and an idler gear in mesh side by side, wherein the drive gear is coupled to the output shaft of the gear set of said drive device.

2. The soap dispensing apparatus of claim 1 wherein in the First packer has in its center a shaft bore for the output shaft of the gear set to extend through; said shaft bore tightly enclosing said output shaft yet allowing it to spin freely.

3. The soap dispensing apparatus of claim 2 wherein the peripheral of the shaft bore of the inlaid board, which allows the output shaft of the gear set to extend through, forms on one side of the inlaid board a telescopic portion, which fits into the annular groove around the shaft bore of the first packer.

4. The soap dispensing apparatus of claim 1 further comprising an adaptor to connect to the outlet passage of the end cover; said adaptor has a fixing rod to embrace the outlet passage of the end cover, and a nut which rotatably fits on the outlet end of the fixing rod.

5. The soap dispensing apparatus of claim 4 further comprising a check ball, which is movably, between outlet passage of the end cover and a port of the fixing rod of the adaptor, pushed against said outlet passage of the end cover during soap dispensing.

6. The soap dispensing apparatus of claim 5 wherein the port of the fixing rod in the adaptor has a plurality of openings in order to keep the liquid soap passing through when the check ball is pushed against it.

7. The soap dispensing apparatus of claim 4 further comprising a socket, disposed at the outlet end of the port of the fixing rod in the adaptor.

8. The soap dispensing apparatus of claim 7 further comprising a countertop soap dispensing spout, with one end inserted in the socket in the adaptor.

9. The soap dispensing apparatus of claim 1 further comprising a soap priming tube fitting on the inlet passage of the end cover.

10. The soap dispensing apparatus of claim 1 further comprising a housing, which has a pair of covers to enclose the soap dispensing apparatus on both sides.

11. The soap dispensing apparatus of claim 10 wherein the lower end of the housing has a nut.

12. The soap dispensing apparatus of claim 4 further comprising a housing having a pair of covers to enclose, on both sides, the assembly of the soap dispensing apparatus and the adaptor.
